(19) United States
(12) Patent Application Publication
(10) Pub. No.: US 2016/0355058 A1
(43) Pub. Date: Dec. 8, 2016

(54) Solid Vacuum Wheel and Tire Configurations and Method

(71) Applicant: Michael Marion McCulley, Benicia, CA (US)

(72) Inventor: Michael Marion McCulley, Benicia, CA (US)

(21) Appl. No.: 14/732,395

(22) Filed: Jun. 5, 2015

(51) Int. Cl. B60C 7/10; B60C 7/24; B60C 25/01; B60C 7/12

(52) U.S. Cl. CPC B60C 7/105; B60C 7/102; B60C 7/125; B60C 7/24; B60C 25/01

(57) ABSTRACT

A Solid Vacuum Wheel and Tire Assembly incorporating a vacuum to adhere a solid vacuum tire in place against a vacuum wheel using the application of a vacuum pressure seal, allowing for safe and reliable operation without flat tires, deflated tires or punctures. Several new configurations of the assembly are possible as well as a new retrofit assembly for existing pneumatic wheel systems. The method of applications and installations are also included.

### FIELD OF THE INVENTION

The present invention relates generally to resilient tires and wheels.

### BACKGROUND OF THE INVENTION

Patented technology has now been introduced, such as the Solid Vacuum Wheel and Tire Assembly, by the same named inventor. The present invention is meant as a continuation-in-part of and expansion of this prior artwork to include new possible configurations, assembly and retrofit operations. Several new configurations are possible. The methods of assembly and installation are also included in this invention for Solid Vacuum Wheel and Tire Assembly applications.

### SUMMARY OF THE INVENTION

The present invention incorporates a solid vacuum wheel and tire assembly that can overcome the disadvantages in conventional pneumatic tires while retaining the advantages of solid tires. The present invention is suitable for automobiles, commercial vehicles, motorcycles or aircraft. The solid vacuum wheel and tire assembly is the first of its kind to incorporate a vacuum compression seal to adhere a solid vacuum tire directly against a vacuum wheel, and this advantage will allow it to achieve non-pneumatic operation without the possibility that the wheel will spin inside the tire during vehicle operation. There is no possibility that the tire on the wheel assembly can go flat or have a blowout, since it is non-pneumatic, and this advantage will provide for a much safer operation. The solid vacuum tire is removed by simply releasing the vacuum pressure seal from the vacuum wheel in order to facilitate removal of the tire.

A spare tire assembly becomes unnecessary due to the present invention, and all jack equipment is also unnecessary due to the fact that there will never be a flat tire to change. The advantage of the absence of an unnecessary spare tire and equipment will decrease the overall weight of the vehicle as well as the space that is needed to house the spare wheel and tire equipment, which will in turn increase the performance of the vehicle. Fuel efficiency or electric range of the vehicle will remain optimum, since there will be no change in tire pressure over the life of the tire, and the rigidity remains constant during the life of the tire. The rigidity of the tire remains constantly set to optimum since it is solid.

Another advantage will be no tire air pressure to check and constantly maintain in the present invention, and the assembly will keep a constant operating vacuum seal over all operating conditions. There will additionally be no moisture inside the tire to cause wheel corrosion over time due to the vacuum seal. The solid vacuum wheel and tire assembly can also be configured for an extremely lightweight low-profile design. There will additionally be no possibility of thermal expansion and failure, since there will be no air to expand. The solid vacuum tire does not roll off of the vacuum wheel assembly due to extreme operating conditions, since the tire is solid with no sidewalls to buckle, and the solid vacuum tire core remains firmly attached. The vacuum back seal can additionally be set to a pressure grater than traditional tire pressure, and this could be a benefit in racing or extreme operating conditions.

The solid vacuum wheel and tire assembly incorporates a flexible tire core that will be able to contract into place after a vacuum is applied. With a vacuum applied to the vacuum wheel, the solid tire core contracts and adheres directly onto the wheel assembly well surface for operation by filling a concave void between the wheel and the tire that is present before the vacuum is applied. Vacuum channels, or holes may be located along the wheel assembly well surface in order to direct an even vacuum seal between the solid flexible inner tire surface and the wheel well surface. As the solid tire rotates, the vacuum seal will keep it adhered to the wheel well surface and wheel rims without separating during operation. The solid tire would be engineered in a convex shape to contract as needed with space built in so that it will not buckle under pressure, but it would fill any void and create a seal onto the vacuum wheel. Additionally, the solid tire sidewalls may be engineered to expand against the outer rims of the vacuum wheel assembly in order to bolster a vacuum seal.

The solid vacuum tire is comprised of a flexible center core comprising of solid or porous rubber, foam core rubber with trapped air bubbles, or a jell and hardener mixture which may be surrounded by a steel belt, if necessary, and further surrounded by a resilient tire tread rubber. Additionally there may be a combination of layered textiles required in order to achieve the desired tire rigidity, which mimics the rigidity of conventional pneumatic tires. One such method or construction would be to inject a liquid rubber compound mixture into a conventional tire design, and then a hardener compound would be added to the liquid mixture until the desired rigidity is achieved. The solid tire would have stiffness and rigidity similar to that of a conventional pneumatic tire, depending on how much hardener was added. The solid vacuum tire is placed onto a vacuum wheel while and then a vacuum is applied. The flexible center tire core contracts and adheres directly against the wheel well surface and remains in place during operation after the vacuum is applied. The vacuum seal is created by the vacuum contracting the flexible center tire core of the solid tire into a void that is present before the vacuum is applied between the flexible center tire core and the wheel well surface. Additionally, a lightweight spacer belt may be added into any solid vacuum wheel and tire assembly in order to decrease overall space or weight. The solid vacuum tire may incorporate a convex shape while a vacuum is not applied in order to allow for a vacuum compression and seal against both the vacuum wheel well surface or spacer belt and the vacuum wheel rims during vacuum application.

Additionally, retrofitted systems may be incorporated. A vacuum valve assembly can be threaded into the rim of existing systems, in order to retrofit pneumatic wheels that are currently in use on vehicles, and render them capable of vacuum operation. A solid vacuum tire would then be installed onto the pneumatic wheel. A spacer belt may be added to reduce excess space or weight between the retrofitted pneumatic wheel and the solid vacuum tire, as needed. The spacer belt may incorporate a layer of resilient rubber in-between the spacer belt and the wheel well surface in order to hold the spacer belt in place onto the pneumatic wheel without slippage during operation. The solid vacuum tire would then contract onto the spacer belt while a vacuum is applied, as it would in a similar setting on a vacuum wheel. The solid tire, spacer belt and wheel would all work in conjunction with one another to stay in place due to the fact that a vacuum seal is applied during operation. This would complete a possible retrofit operation. An object, such as a nail, would be able to penetrate into the tire tread, core or sidewall without the tire losing any air, such as in conventional pneumatic tires. The retrofitted solid vacuum wheel and tire assembly will provide an extremely safe, efficient and reliable tire incapable of going flat or having a catastrophic failure, such as a blowout.

The spacer belt is comprised of spacer brackets that may be comprised of metal, wood, or plastic textiles that are linked together as a chain by metal wire, plastic cable or bands. The spacer belt would act similar to tire chains, but it would be used simply to take up excess space or weight in the operation, if necessary, depending on the design of the wheel in use. A benefit of the spacer belt being a chain of brackets is that there will be space between the brackets to direct the vacuum pressure, and the connection point between the solid vacuum tire and spacer belt can have ridges or grooves similar the vacuum wheel in order to provide for a strong vacuum compression seal that adheres the tire in place during operation. The spacer brackets can also mimic the shapes of the wheel well surface, as needed.

A method of the application and installation of the solid vacuum wheel and tire assembly would be to first i install a vacuum valve assembly into a vacuum wheel, or a pneumatic wheel in order to retrofit. Secondly a spacer belt may be added in order to save space or weight in the assembly, if necessary. Next, a solid vacuum tire would be installed over the rim of the wheel and onto the vacuum wheel assembly. Finally, the vacuum pressure from a source, such as an air compressor vacuum, would be applied through the vacuum valve assembly. The solid vacuum tire core would then compress and seal into place onto the vacuum wheel well surface. The solid vacuum wheel and tire assembly would then be installed onto vehicles for safe and reliable non-pneumatic operation. The removal of the solid vacuum tire would be accomplished by releasing the vacuum seal and replacing the tire.

This solid tire advantage will achieve a consistent tire rigidity and therefore optimal fuel efficiency or electric range during vehicle operation, since there will be no air pressure to leak out over time. The consistent tire rigidity will mimic conventional pneumatic tires, but will not have the fluctuation of performance associated with air leakage. The continuously ridged tire will also maintain optimal wear over time, commonly associated with properly inflated tires. Additionally, silica can optionally replace some of the carbon black in the tire tread rubber to prevent tire hysteresis, and the tire flexible center core material can be configured to decrease tire deformation on the ground surface, commonly associated with low-rolling resistance tires, and increased handling characteristics. Tire roll will be reduced, due to the fact that there will be more structure built into a solid vacuum tire design, and this benefit will add to overall vehicle handling consistency. There will additionally be no spare tire components required. This invention will be suitable for new vehicles or to retrofit existing systems. This invention will be more suitable for electric power generating systems to be built inside the solid vacuum tire, since there will be more structure in the solid tire core to accommodate system components. A flat tire, deflated tire or puncture will be impossible in the solid vacuum tire that can now easily be removed and replaced.

### BRIEF DESCRIPTION OF THE FIGURES

FIG. 1a represents a solid vacuum wheel and tire assembly configuration.

FIG. 1b represents a solid vacuum wheel and tire assembly wheel with circular circumference vacuum channels.

FIG. 1c represents a solid vacuum wheel and tire assembly wheel with a vacuum cross channel.

FIG. 2a represents a cross section of a solid vacuum wheel and tire assembly with no vacuum applied and a convex solid tire.

FIG. 2b represents a cross section of a solid vacuum wheel and tire assembly with a vacuum seal applied and a compressed solid tire.

FIG. 3a represents a cross section of a solid vacuum wheel and tire assembly retrofit with no vacuum applied and a convex layered solid tire.

FIG. 3b represents a cross section of a solid vacuum wheel and tire assembly retrofit with a vacuum seal applied and a compressed layered solid tire.

FIG. 4a represents a cross section of a standard pneumatic wheel.

FIG. 4b represents a standard pneumatic wheel with a spacer belt installed.

FIG. 4c represents a spacer belt before installation, with numerous spacer brackets.

FIG. 4d represents a single spacer bracket.

FIG. 5a represents a solid vacuum wheel and tire assembly wheel with vacuum holes and a concave shape

FIG. 5b represents a solid vacuum wheel and tire assembly wheel with vacuum holes and a convex shape.

### DETAILED DESCRIPTION OF THE FIGURES

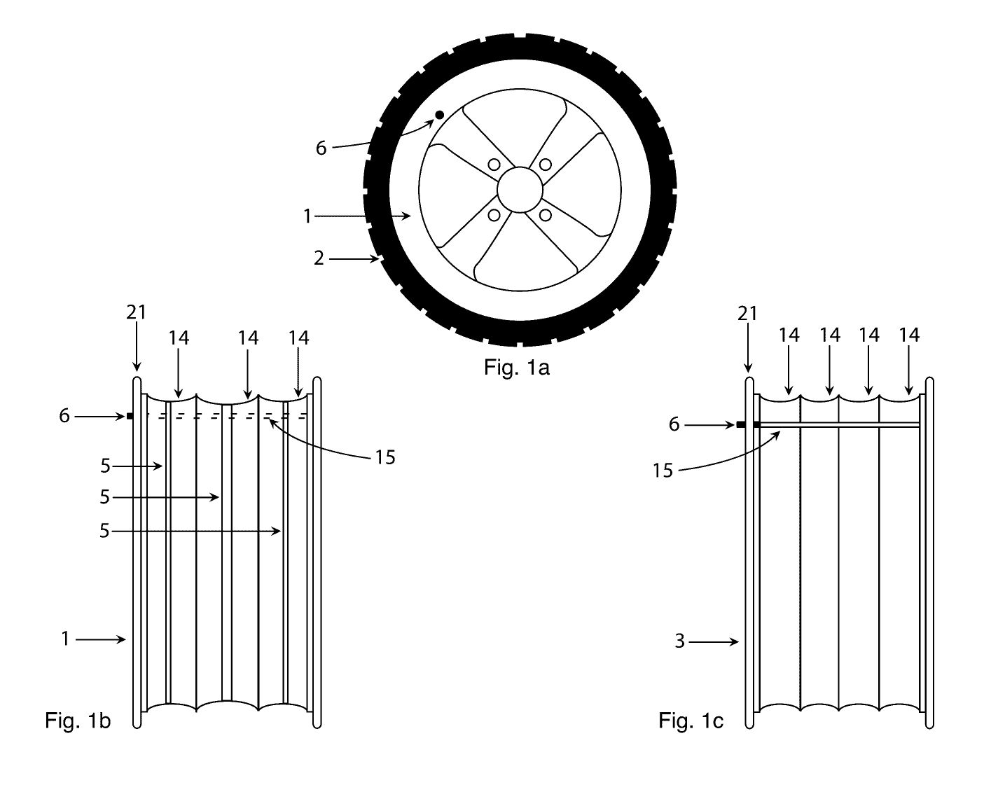

FIG. 1a represents a solid vacuum wheel and tire assembly, vacuum wheel 1 and solid vacuum tire 2, side view, with a vacuum valve assembly 6 installed.

FIG. 1b represents the vacuum wheel 1 with concave well grooves 14 and circular circumference vacuum channels 5 connected by a vacuum valve assembly 6 and a vacuum cross channel 15 under the well surface. The rim 21 of the wheel 1 will help to keep a solid vacuum tire in place during operation.

FIG. 1c represents a vacuum wheel 3 with concave well grooves 14 and a vacuum cross channel 15 across the wheel well surface connected to a vacuum valve assembly 6. The rim 21 of the wheel 3 will help to keep a solid vacuum tire in place during operation.

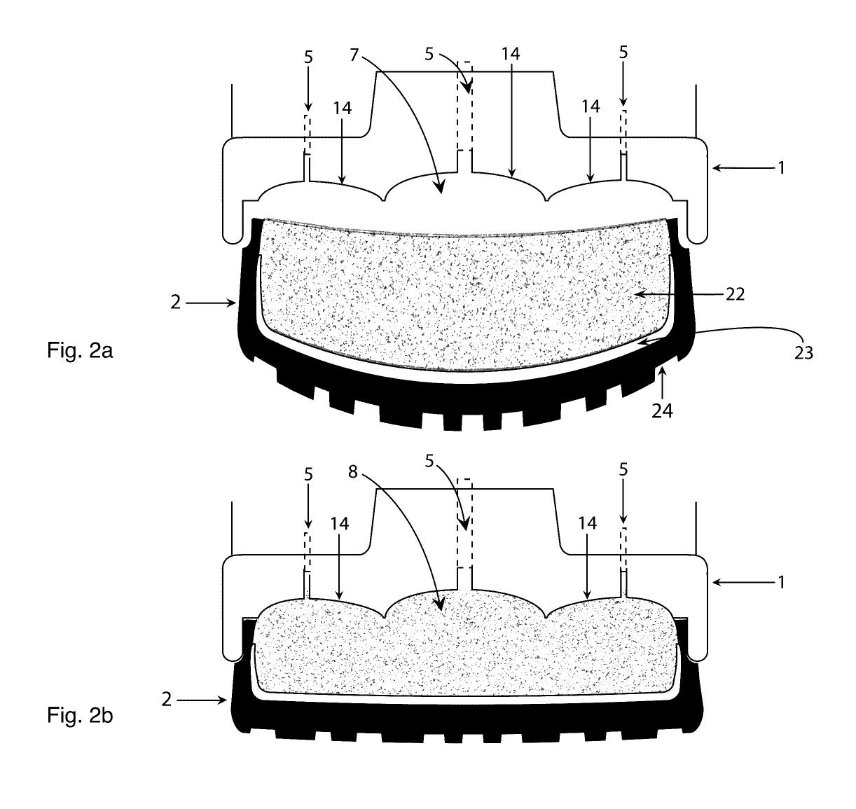

FIG. 2a represents a cross section of a solid vacuum wheel and tire assembly, vacuum wheel 1 and solid vacuum tire 2, and vacuum channels 5 and concave well grooves 14 with a void 7 before a vacuum seal is applied. The solid tire 2 is comprised of resilient tire tread rubber 24 and a steel belt 23 and a flexible center tire core material comprised of a jell and hardener mixture 22. The convex shape of the solid tire 2 will allow space for solid vacuum tire compression and seal.

FIG. 2b represents a cross section of a solid vacuum wheel and tire assembly, vacuum wheel 1 and solid vacuum tire 2, and the vacuum channels 5 and concave well grooves 14 with a vacuum pressure 8 after the vacuum seal is applied.

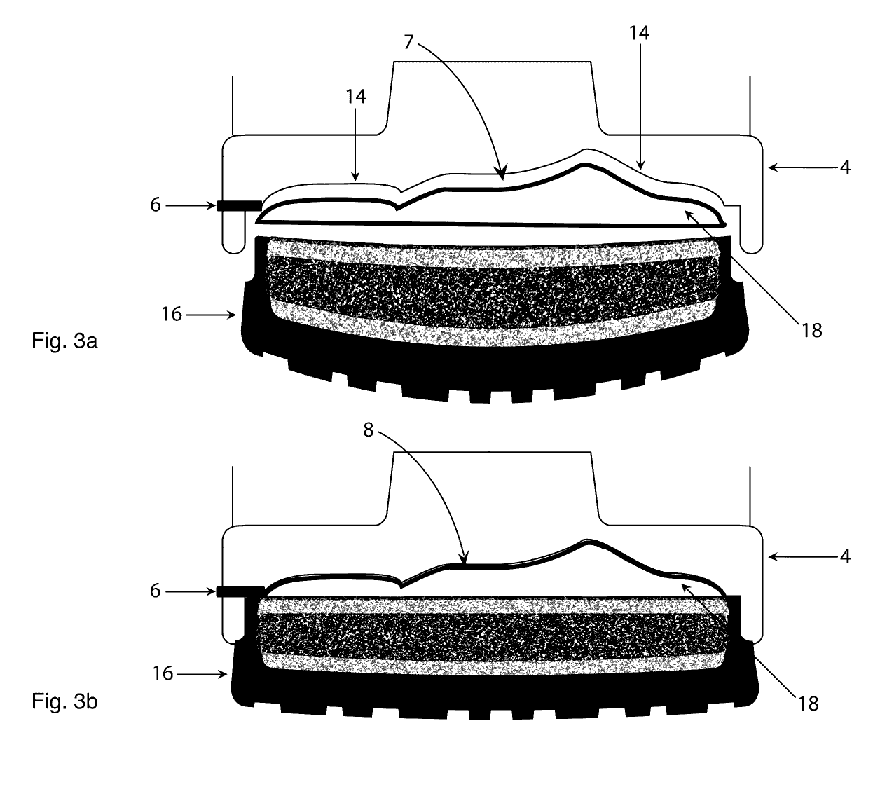

FIG. 3a represents a cross section of a solid vacuum wheel and tire assembly, pneumatic wheel 4 and solid vacuum tire 16, and concave well grooves 14 with a void 7 before a vacuum seal is applied through a vacuum valve assembly 6. A single spacer bracket 18 conforms in shape to the wheel well surface. The solid tire 16 is comprised of layers of solid or porous rubber textiles. The convex shape of the solid tire 16 will allow space for solid vacuum tire compression and seal.

FIG. 3b represents a cross section of a solid vacuum wheel and tire assembly, pneumatic wheel 4 and solid vacuum tire 16, with a vacuum seal 8 after the vacuum is applied through the vacuum valve assembly 6 and around the single spacer bracket 18.

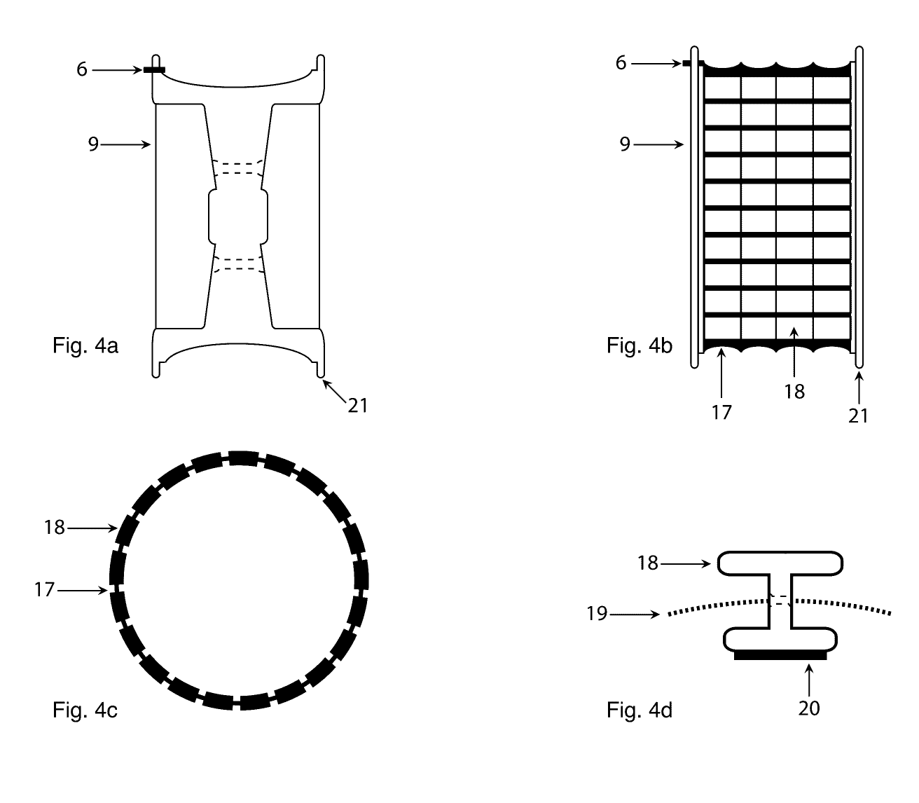

FIG. 4a represents a cross section of a pneumatic wheel 9 with a retrofit of a vacuum valve assembly 6 installed rendering it capable of excepting vacuum pressure. The rim 21 of the wheel 9 will help to keep a solid vacuum tire in place during operation.

FIG. 4b represents a pneumatic wheel 9 with the retrofit of a vacuum valve assembly 6 installed and a spacer belt 17 installed. The spacer belt 17 is comprised of numerous spacer brackets 18 that are linked together as a chain. The rim 21 of the wheel 9 will help to keep a solid vacuum tire in place during operation.

FIG. 4c represents a spacer belt 17 before installation, and is comprised of numerous spacer brackets 18 linked together as a chain by metal wire, plastic cable or bands.

FIG. 4d represents a single spacer bracket 18 with a resilient rubber base 20 in order to stop slippage. The spacer bracket 18 may be metal, wood or plastic textiles. The spacer bracket 18 may be linked to other spacer brackets as a chain 19 by metal wire, plastic cable or bands. The single spacer bracket 18 may also conform in shape to a wheel well surface, as necessary.

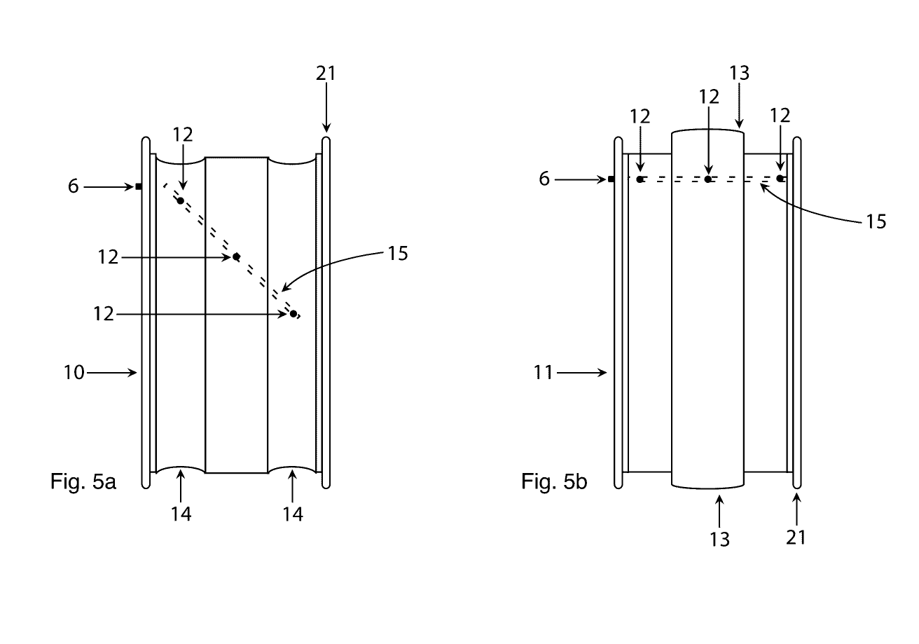

FIG. 5a represents a vacuum wheel 10 with vacuum holes 12 and concave well grooves 14, connected by a vacuum valve assembly 6 and a vacuum cross channel 15 under the wheel well surface. The rim 21 of the wheel 10 will help to keep a solid vacuum tire in place during operation.

FIG. 5b represents a vacuum wheel 11 with vacuum holes 12 and a convex well shape 13 of the wheel well surface in order to take up space in a solid vacuum tire, connected by a vacuum valve assembly 6 and a vacuum cross channel 15 under the wheel well surface. The rim 21 of the wheel 11 will help to keep the solid vacuum tire in place during operation.

What is claimed is:

1. A solid vacuum wheel and tire assembly, comprising of a vacuum wheel assembly and a solid vacuum tire, wherein the solid vacuum tire is comprised of a flexible center tire core comprising of solid or porous rubber textiles, or a jell and hardener mixture that mimics pneumatic tire rigidity and further surrounded by a resilient tire tread rubber, wherein a vacuum valve assembly may be installed into a vacuum channel, wherein the vacuum valve assembly is installed into the vacuum wheel, wherein the solid vacuum tire is installed onto the vacuum wheel assembly, wherein the flexible center tire core of the solid vacuum tire compresses, seals and adheres directly into place onto the vacuum wheel well surface and wheel rims while a vacuum is applied, wherein the flexible center tire core compresses, seals and adheres directly against the vacuum wheel well surface and wheel rims and remains in place during vehicle operation after the vacuum is applied, wherein a vacuum seal is created by the vacuum compressing the flexible center tire core into a void that is present before the vacuum is applied between the flexible center tire core and the vacuum wheel, wherein the solid vacuum tire remains in place and directly in contact with the vacuum wheel assembly during non-pneumatic vehicle operation, wherein a spacer belt may optionally be installed onto the vacuum wheel in order to save space or weight, wherein a removal of the solid vacuum tire is accomplished by releasing the vacuum seal and replacing the solid vacuum tire.

2. A solid vacuum wheel and tire assembly as in claim 1, further comprising of a retrofit assembly, wherein a pneumatic wheel is fitted with the retrofit consisting of the vacuum valve assembly, wherein the vacuum valve assembly is installed into the pneumatic wheel and renders it capable of excepting vacuum pressure, wherein the spacer belt may be installed onto the pneumatic wheel well surface and in order to save space or weight, as needed, wherein the spacer belt is comprised of spacer brackets linked together as a chain, wherein the spacer brackets may be comprised of metal, wood or plastic textiles and a resilient rubber base, wherein the spacer brackets may be linked together by metal wire, plastic cable or bands, wherein the spacer brackets may conform to the wheel well shape, wherein the spacer brackets may also be concaved shaped or convex shaped, as needed in order to adhere to the solid vacuum tire.

3. A solid vacuum wheel and tire assembly as in claim 1, further comprising of the vacuum wheel, wherein the vacuum wheel configurations may be comprised of circular circumference vacuum channels, vacuum holes or vacuum cross channels, wherein the vacuum wheel assembly channels may be on the wheel well surface or under the wheel well surface, wherein concave well grooves may be added in order to keep the solid vacuum tire in place during vehicle operation, wherein the wheel well surface may be concaved shaped or convex shaped as needed, wherein rims of the vacuum wheel can additionally keep the solid vacuum tire in place during vehicle operation, wherein the vacuum valve assembly is installed into the vacuum wheel in order to apply the vacuum.

4. A solid vacuum wheel and tire assembly as in claim 1, further comprising of the solid vacuum tire, wherein the solid vacuum tire configurations may be layered and comprised of the flexible center tire core, wherein the solid vacuum tire may be comprised of solid or porous rubber textiles, foam core rubber with trapped air bubbles, or the jell and hardener mixture and are configured to mimic pneumatic tire rigidity and further surrounded by the resilient tire tread rubber, wherein the solid vacuum tire may consist of layers of textiles in order to achieve the mimic of pneumatic tire rigidity, wherein the solid vacuum tire may optionally incorporate a steel belt, wherein the solid vacuum tire may incorporate a convex shape while the vacuum is not applied in order to allow for vacuum compression and seal against both the vacuum wheel well surface or the spacer belt and the wheel rims during vacuum pressure application.

5. A method of application and installation using the solid vacuum wheel and tire assembly of claim 1, wherein the vacuum wheel is fitted with the vacuum valve assembly, wherein the spacer belt may be installed onto the vacuum wheel, as needed, wherein the solid vacuum tire is installed onto the vacuum wheel assembly over the vacuum wheel rim, wherein the vacuum is applied through the vacuum valve assembly, wherein the flexible center tire core of the solid vacuum tire compresses, seals and adheres directly against the vacuum wheel well surface or the spacer belt surface and the wheel rims and remains in place during vehicle operation, wherein the solid vacuum wheel and tire assembly is installed onto vehicles, wherein the removal of the solid vacuum tire is accomplished by releasing the vacuum seal and replacing the solid vacuum tire.

6. A method of application and installation using the solid vacuum wheel and tire assembly of claim 2, comprising of the retrofit assembly, wherein the pneumatic wheel is fitted with the vacuum valve assembly rendering it capable of excepting vacuum pressure, wherein the spacer belt may be installed onto the pneumatic wheel as needed, wherein the solid vacuum tire is installed onto the pneumatic wheel assembly over the pneumatic wheel rim, wherein the vacuum is applied through the vacuum valve assembly, wherein the flexible center tire core of the solid vacuum tire compresses, seals and adheres directly against the pneumatic wheel well surface or the spacer belt surface and wheel rims and remains in place during vehicle operation, wherein the solid vacuum wheel and tire assembly is installed onto vehicles, wherein the removal of the solid vacuum tire is accomplished by releasing the vacuum seal and replacing the solid vacuum tire.

7. A method of applying and installing a solid vacuum tire onto a vacuum wheel or a pneumatic wheel or a spacer belt, using the application of a vacuum seal.
